(19) United States
(12) Patent Application Publication
(10) Pub. No.: US 2002/0156676 A1
(43) Pub. Date: Oct. 24, 2002

(54) System, method, and apparatus for creating and securely managing accounts holding cash equivalents

(76) Inventors: John C. Ahrens, Scotts Valley, CA (US); Joerg U. Ferchau, Morgan Hill, CA (US)

Correspondence Address: SKJERVEN MORRILL LLP, 25 METRO DRIVE, SUITE 700, SAN JOSE, CA, 95110, US

(21) Appl. No.: 09/836,302

(22) Filed: Apr. 17, 2001

(51) Int. Cl. G06F 17/60

(52) U.S. Cl. 705/14

(57) ABSTRACT

A system, method, and apparatus for creating and securely managing accounts holding cash equivalents is disclosed. Using the system, method, and apparatus of the present invention, a business can issue an account to a consumer. The account holds cash equivalents such as electronic cash, loyalty points, or the like. When a consumer makes a purchase from the business, the value of the account increases. The purchase may be made using cash, checks, or credit cards issued by the business. Generally, the value of the account will not be increased if the consumer makes a purchase using a third party credit card such as a Visa or MasterCard. Once a consumer's account has reached a sufficient value, the consumer can use the value of the account to purchase goods and/or services from the business that issued the account. Thus, by increasing the amount of cash equivalents in a consumer's account, the consumer has an incentive to purchase goods and/or services from the business.

### BACKGROUND

1. Field of the Invention

The present invention relates generally to commerce and, more specifically, to a system, method, and apparatus for creating and securely managing accounts holding cash equivalents for use in commerce.

2. Related Art

Businesses are faced with numerous challenges. First, it is difficult for businesses to attract and retain a loyal consumer base. Establishing and retaining a loyal consumer base often requires a business to offer consumers a variety of purchasing incentives such as coupons or discounts. Additionally, the coupons and discounts need to be distinguishable or more appealing than the coupons or discounts offered by a competitor. Thus, it would be advantageous if businesses could generate incentives which are unique and which improve consumer loyalty.

Second, it is difficult for businesses to encourage consumers to make purchases using a business' e-commerce enabled web site. Many consumers prefer making purchases in traditional brick and mortar establishments. However, the cost of operating such establishments is high due to overhead costs. Thus, it would be advantageous if businesses could encourage consumers to make purchases using the business' e-commerce enabled web site.

Third, it is difficult for businesses to encourage consumers to use credit cards issued by the business. Typically, consumers use credit cards issued by third party credit card companies such as Visa or MasterCard. When a consumer makes a purchase using a third party credit card, the business must pay the third party credit card company a transaction fee (e.g., 3% of the purchase price). This reduces the business' profits. In addition, when a consumer makes a purchase using a third party credit card, the third party credit card company earns interest revenue on a consumer's unpaid credit card balance, rather than the business. Thus, it would be advantageous if businesses could encourage consumers to use credit cards issued by the businesses rather than a third party credit card company.

Fourth, it is difficult for businesses to generate information to run successful direct marketing campaigns. Directly marketing goods and/or services to consumers who are interested in such goods and/or services is a very effective marketing technique. However, generating data that indicates which consumers are interested in particular goods and/or services is difficult and expensive. Thus, it would be advantageous if businesses could improve their direct marketing capabilities.

Fifth, it is expensive for businesses to implement new consumer technologies into their existing infrastructures. New technologies require businesses to rebuild their existing infrastructures. For example, if a retail business would like to accept so called “smart cards,” the business would have to install smart card readers. However, installing smart card readers is expensive. Thus, it would be advantageous if businesses could implement new consumer technologies without having to make major improvements to their existing infrastructures.

What is needed is a system, method, and apparatus that overcomes the disadvantages and limitations mentioned above.

### SUMMARY OF THE INVENTION

The present invention provides a system, method, and that overcomes the disadvantages and limitations mentioned above. This is accomplished by providing a system, method, and apparatus for creating and securely managing accounts holding cash equivalents. Using the system, method, and apparatus of the present invention, a business can issue an account to a consumer. The account holds cash equivalents such as electronic cash, loyalty points, or the like. When a consumer makes a purchase from the business, the value of the account increases. The purchase may be made using cash, checks, or credit cards issued by the business. Generally, the value of the account will not be increased if the consumer makes a purchase using a third party credit card such as a Visa or MasterCard. Once a consumer's account has reached a sufficient value, the consumer can use the value of the account to purchase goods and/or services from the business that issued the account. Thus, by increasing the amount of cash equivalents in a consumer's account when the consumer makes a purchase from a business, the consumer has an incentive to purchase goods and/or services from the business.

The account issued by the business to the consumer is generally stored in a database on a secure computer system. The computer system can be located at and managed by the business. Alternatively, the computer system can be located at and managed by an application service provider, which may manage accounts for multiple businesses. In either case, one or more computer programs running on the computer system maintain, manage, permit or deny access to, increment or decrement the value of, and perform other tasks relating to the account.

A wide variety of devices can be used to access the account such as electronic cash registers, point-of-sale terminals, debit/credit terminals, electronic kiosks, cellular telephones, personal digital assistants, home computers, and/or business computers. The account can be accessed by the consumer at the business or in a mobile, home, or office environment. One or more computer programs run on the devices. The computer programs enable the consumer to access the account. Once accessed, the information such as the account balance or the transaction history can be communicated to the consumer. Additionally, the consumer can make purchases using the cash equivalents in the account.

The computer programs running on the devices and the computer programs running on the computer system (at the business or an application service provider) communicate with one another by generating and sending messages to one another. The messages are generally encrypted and transmitted over a secure network, which is similar to conventional secure financial networks.

Other aspects and advantages of the present invention will become apparent from the following descriptions, the accompanying drawings, and the accompanying claims.

### BRIEF DESCRIPTION OF THE DRAWINGS

For a more complete understanding of the present invention and for further features and advantages, reference is now made to the following description taken in conjunction with the accompanying drawings, in which:

FIG. 1A is a block diagram of an exemplary system in which accounts are stored and managed by a business, according to some embodiments of the present invention.

FIG. 1B is a block diagram of an exemplary system in which accounts are stored and managed by an application solution provider, according to some embodiments of the present invention.

FIG. 2 is a block diagram of an exemplary device, according to some embodiments of the present invention.

FIG. 3 is a block diagram of an exemplary application service provider, according to some embodiments of the present invention.

FIG. 4A is a block diagram of exemplary applications which run on an application service provider, according to some embodiments of the present invention.

FIG. 4B is a block diagram of an exemplary database, according to some embodiments of the present invention.

FIG. 4C is a block diagram of an exemplary security module, according to some embodiments of the present invention.

FIG. 5 is a flowchart of an exemplary method for generating a consumer account, according to some embodiments of the present invention.

FIG. 6 is a flowchart of an exemplary method for increasing the value of a consumer account, according to some embodiments of the present invention.

FIG. 7 is a flowchart of an exemplary method for generating a coupon or voucher, according to some embodiments of the present invention.

FIG. 8 is a flowchart of an exemplary method for distributing benefits, according to some embodiments of the present invention.

### DETAILED DESCRIPTION OF THE INVENTION

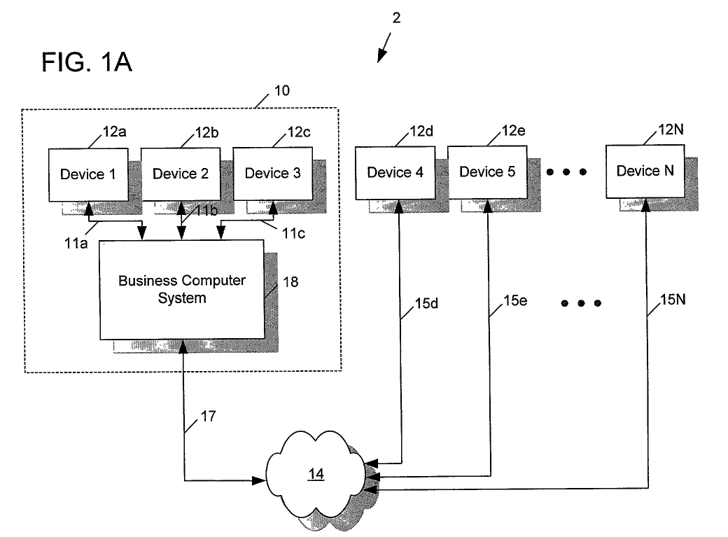

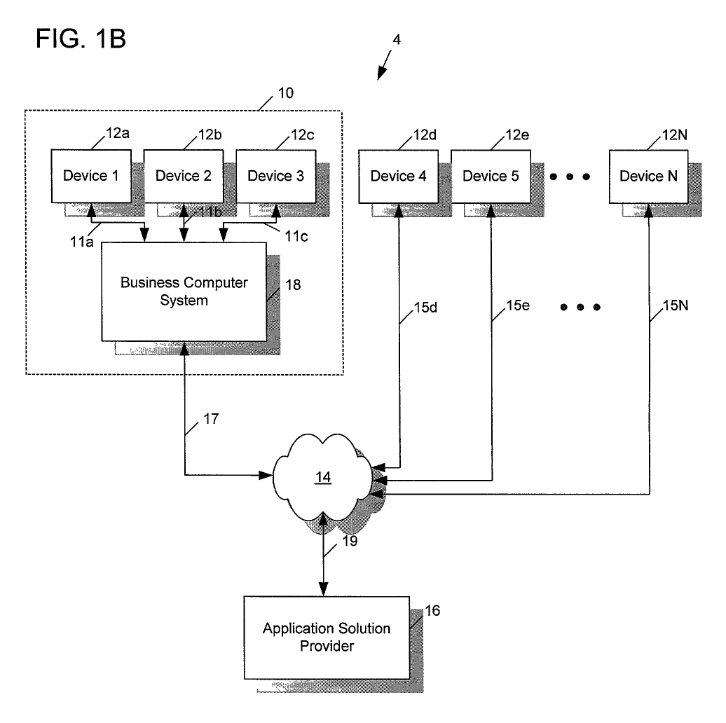

The preferred embodiments of the present invention and their advantages are best understood by referring to FIGS. 1 through 8 of the drawings and the definitions provided below. Like numerals are used for like and corresponding parts of the various drawings.

Definitions

For a more complete understanding of the present invention, the following definitions are provided:

As used herein, the term “consumer” refers to a purchaser or buyer of goods and/or services. A consumer can be any type of purchaser such as a retail purchaser or wholesale purchaser. A consumer can also represent one who receives goods and/or services without having to pay cash for such goods and/or services such as a recipient of benefits like government issued food stamps or vouchers.

As used herein, the term “business” refers to an entity that offers goods and/or services in return for cash, checks, credit, or the like such as a sole-proprietorship, a retail business, or a wholesale businesses. A business can also represent an entity that offer goods and/or services without requiring cash payment such as a government agency, an institution, a non-profit organization, or the like. Such entities may distribute benefits such as food stamps, medical benefits, vouchers, or coupons.

As used herein, the term “cash equivalent” refers to currency, incentives, loyalty points, or the like which can be used by a consumer as traditional cash, a percentage discount, a coupon, or the like when the consumer purchases goods and/or services. An important feature of the cash equivalents described in the present invention is that they are unique to a specific business. In other words, the cash equivalents are “branded.” For example, Business A may issue Business A-type cash equivalents which can only be used at Business A, Business B can issue Business B-type cash equivalents which can only be used at Business B, Business C can issue Business C-type cash equivalents which can only be used at Business C, and so on. In some cases, a business may honor another business' cash equivalents, such as when the two businesses have common ownership or a joint agreement to honor each other's cash equivalents.

As used herein, the term “account” or “cash equivalent account” refers to an account that has been issued by a business to a consumer. For example, Consumer 1 may have a cash equivalent account with Business A. Consumer 1 can, among other things, access the account to determine the account balance and use the cash equivalents in the account to make purchases at Business A. Consumer 1 may also have similar cash equivalent accounts at Business B, Business C, and so on.

As used herein, the term “connection” refers to any type of connection between two or more electronic devices that allows data/information to be transferred unidirectionally or bi-directionally between the two or more devices. For example, a connection may be an electrical connection, a wireless connection, or an optical connection. A connection may include one or more networks, gateways, bridges, routers, or any combination thereof.

As used herein, the term “network” refers to a series of points or nodes interconnected by communication paths. For example, a network may be a local area network, a metropolitan area network, a wide area network, or a global area network such as the Internet.

As used herein, the term “computer” or “server” refers to one or more computers which include one or more suitable microprocessors. For example, a computer or server may be a personal computer, a laptop computer, a mainframe, a file server, a workstation, or any other suitable data processing facility. A computer or server may operate under the control of any suitable operating system such as MS-DOS, MacINTOSH OS, WINDOWS NT, WINDOWS 98, OS/2, AIX, OS/390, VMS, UNIX, XENIX, and the like.

System Architecture

FIG. 1A is a block diagram of an exemplary system 2 in which accounts are stored and managed by a business 10, according to some embodiments of the present invention. System 2 includes a plurality of devices 12N (where N=a, b, c, d, e, etc.), some of which are located at business 10 (i.e., devices 12a, 12b, and 12c) and some of which are located outside of business 10 (i.e., devices 12d, 12e, . . . , 12N), and a network 14.

Devices 12a, 12b, and 12c can be electronic devices which are typically located at a business such as electronic cash registers (ECR), point-of-sale (POS) terminals, debit/credit terminals, and electronic kiosks. Devices 12d, 12e, . . . , 12N can be electronic devices which are typically located outside a business in a mobile environment (e.g., a cellular telephone or a wireless personal digital assistant), a home (e.g., a computer located in a home), or a business (e.g., a computer located in a business).

Each of devices 12a, 12b, and 12c are connected to business computer system 18 via respective connections 11a, 11b, and 11c. Connections 11a, 11b, and 11c can be any type of connections which allow messages containing data/information to be transferred between devices 12a, 12b, and 12c and business computer system 18. Business computer system 18 is connected to network 14 via connection 17. Connection 17 can be any type of connection which allows messages containing data/information to be transferred between business computer system 18 and network 14. Each of devices 12d, 12e, . . ., 12N are connected to network 14 via respective connections 15d, 15e, . . ., 15N. Connections 15d, 15e, . . . , 15N can be any type of connections which allow messages containing data/information to be transferred between devices 12d, 12e, . . . , 12N and network 14.

Network 14 can be any type of network which is capable of transferring messages containing data/information between devices 12d, 12e, . . . , 12N and business 10 such as the Internet. Network 14, connections 15d, 15e, . . . , 15N, and connection 17 form a secure system for transmitting messages between devices 12 and business 10. This secure system is similar to conventional secure financial networks such as electronic fund transfer (EFT) networks or point-of-sale (POS) networks. A high level of security is necessary since messages, which include cash equivalents and information relating to such cash equivalents, are transmitted over network 14.

Business 10 includes a business computer system 18 which generally includes one or more computers (not shown) connected to a database (not shown). The database includes a plurality of accounts issued by the business to consumers. The computers are capable of generating, storing, accessing, increasing or decreasing the value of, and otherwise managing the accounts.

In operation, accounts issued to consumers by business 10 can be generated and stored in the database on business computer system 18. When the accounts are generated, the consumer provides information which associates the consumer with the account. For example, the consumer may provide their name, home address, email address, a password, a bio-metric identification, a hardware token, or an identification code embedded in the magnetic strip of a magnetic card. This information can be collected by devices 12 and stored in the database on business computer system 18. The consumer can then use devices 12 to access their account. Once accessed, the consumer can review the account balance, review the transaction history, and use the balance of the cash equivalents in the account to purchase goods and/or services from the business. When the consumer purchases goods and/or services from the business, the value of the cash equivalents in the account can be increased. Such purchases may be made using cash, a check, or a credit card issued by the business. Generally, purchases made using third party credit cards will not increase the value of the cash equivalents in the consumer's account.

FIG. 1B is a block diagram of an exemplary system 4 in which accounts are stored and managed by an application service provider (ASP) 16, according to some embodiments of the present invention. System 4 can be used as an alternative to system 2 described with reference to FIG. 1A.

Like system 2, system 4 includes a plurality of devices 12N (where N=a, b, c, d, e, etc.), some of which are located at business 10 (i.e., devices 12a, 12b, and 12c) and some of which are located outside of business 10 (i.e., devices 12d, 12e, . . . , 12N), and a network 14. System 4 also includes ASP 16 which is connected to network 14 via a connection 19. Connection 19 can be any type of connection which allows messages containing data/information to be transferred between ASP 16 and network 14.

Devices 12a, 12b, and 12c can be electronic devices which are typically located at a business such as electronic cash registers (ECR), point-of-sale (POS) terminals, debit/credit terminals, and electronic kiosks. Devices 12d, 12e, . . . , 12N can be electronic devices which are typically located outside a business in a mobile environment (e.g., a cellular telephone or a personal digital assistant), a home (e.g., a computer located in a home), or a business (e.g., a computer located in a business).

Each of devices 12a, 12b, and 12c are connected to business computer system 18 via respective connections 11a, 11b, and 11c. Connections 11a, 11b, and 11c can be any type of connections which allow messages containing data/information to be transferred between devices 12a, 12b, and 12c and business computer system 18. Business computer system 18 is connected to network 14 via connection 17. Connection 17 can be any type of connection which allows messages containing data/information to be transferred between business computer system 18 and network 14. Each of devices 12d, 12e, . . ., 12N are connected to network 14 via respective connections 15d, 15e, . . . , 15N. Connections 15d, 15e, . . . , 15N can be any type of connections which allow messages containing data/information to be transferred between devices 12d, 12e, . . . , 12N and network 14.

Network 14 can be any type of network which is capable of transferring messages containing data/information between devices 12d, 12e, . . . , 12N, business 10, and ASP 16 such as the Internet. Network 14 and connections 15, 17, and 19 form a secure system for transmitting messages between devices 12d, 12e, . . . , 12N, business 10, and ASP 16. This secure system is similar to conventional secure financial networks such as electronic fund transfer (EFT) networks or point-of-sale (POS) networks. A high level of security is necessary since messages, which include cash equivalents and information relating to such cash equivalents, are transmitted over network 14.

ASP 16 includes one or more computers (not shown) connected to a database (not shown). The database includes a plurality of accounts issued by one or more businesses to consumers. The computers are capable of generating, storing, accessing, increasing or decreasing the value of, and otherwise managing the accounts. Thus, the computers at ASP 16 perform functions which are similar to those performed by business computer system 18 described with reference to FIG. 1A.

In operation, accounts issued to consumers by one or more businesses can be generated and stored in the database at application service provider 16. When the accounts are generated, the consumer provides information which associates the consumer with the account. For example, the consumer may provide their name, home address, email address, a password, a bio-metric identification, a hardware token, and/or an identification code embedded in the magnetic strip of a magnetic card. In addition, the business provides information which associates the business with the account. For example, the business may provide its name, address, and/or an identification code. ASP 16 uses the information provided by the consumer and the information provided by the business to identify the account. Once the account has been generated, the consumer can then use devices 12 to access their account, The consumer can review the account balance, review the transaction history, and use the balance of the cash equivalents in the account to purchase goods and/or services from the business. When the consumer purchases goods and/or services from the business, the value of the cash equivalents in the account can be increased. Such purchases may be made using cash, a check, or a credit card issued by the business. Generally, purchases made using third party credit cards will not increase the value of the cash equivalents in the consumer's account.

Device Architecture

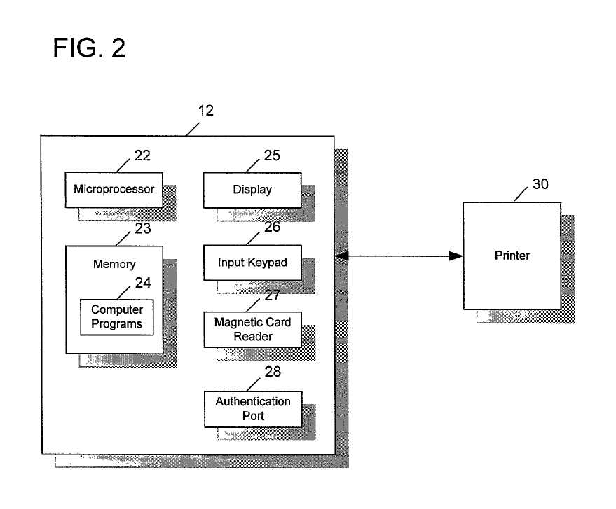

FIG. 2 is a block diagram of an exemplary device 12, according to some embodiments of the present invention. Device 12 includes the following components: a microprocessor 22 which is capable of executing one or more computer programs 24 stored in memory 23, a display 25, an input keypad 26, a magnetic card reader 27, and an authentication port 28. Computer programs 24 may have a segmented architecture which allows such computer programs 24 or portions thereof to be updated quickly and without interrupting the operation of device 12. Device 12 is connected to a conventional printer 30. For clarity, connections between the components of device 12 are not shown.

Although exemplary device 12 includes microprocessor 22, memory 23, display 25, input keypad 26, magnetic card reader 27, and authentication port 28, and is attached to printer 30, it should be recognized that other devices 12 used in systems 2 and 4 may not include all of these components and/or may include additional components. For example, a device 12 which is a cellular telephone may not include a magnetic card reader or be connected to a printer.

In operation, device 12 accepts input information from a consumer via input keypad 26, magnetic card reader 27, and/or authentication port 28. The information is received by the computer programs 24 located in memory 23. The computer programs can then process the input information and generate and transmit the messages in response to the input information. The computer programs may encrypt the messages prior to transmission. The computer programs can also receive messages. If the messages are encrypted, the computer programs 24 decrypt the messages. The information contained in the messages can be displayed on display 25 or printed via printer 30.

Application Solution Provider Architecture

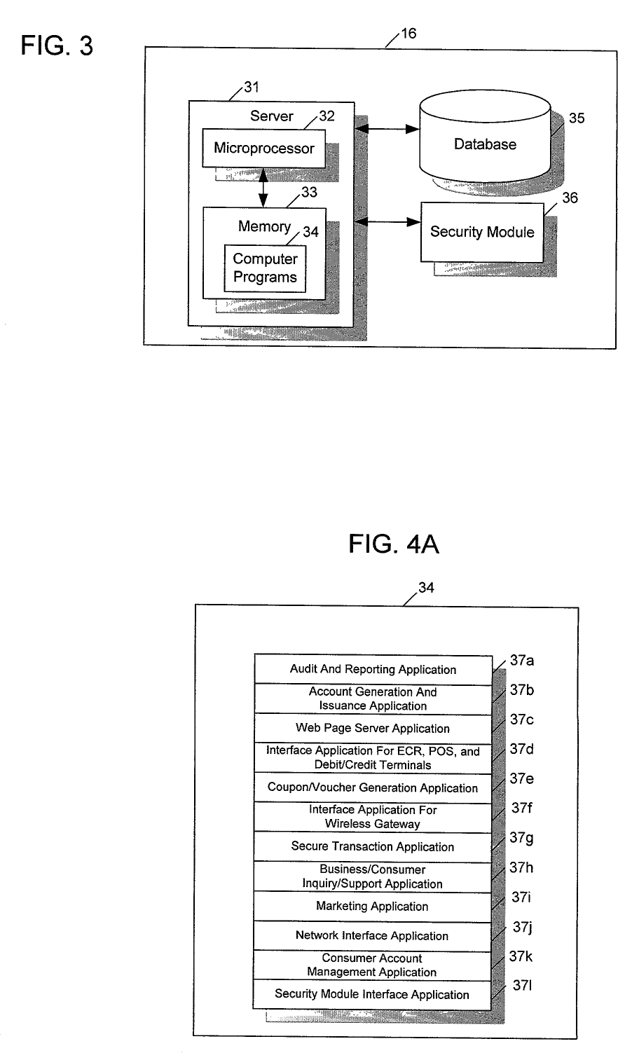

FIG. 3 is a block diagram of an exemplary application service provider (ASP) 16, according to some embodiments of the present invention. ASP 16 includes a server 31 having a microprocessor 32 which is capable of executing one or more computer programs 34 stored in memory 33, a database 35 connected to server 31, and a security module 36 connected to server 31. Server 31 may include a plurality of physical server computers (e.g., a server farm or cluster), and computer programs 34 may run on one or more of the plurality of server computers.

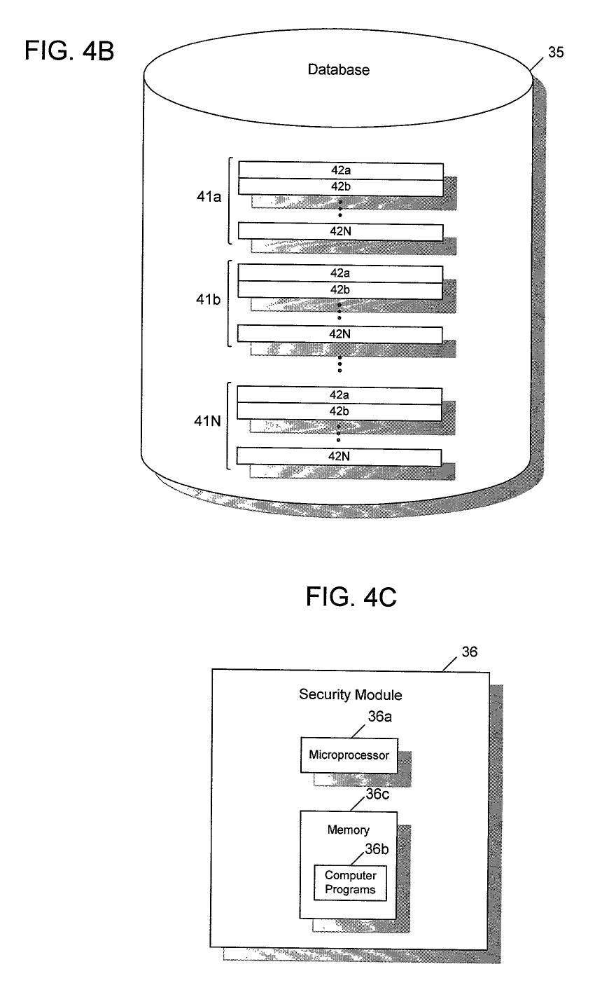

FIG. 4A is a diagram of exemplary applications 37 which are included in computer programs 34 of FIG. 3, according to some embodiments of the present invention. The various applications include: an audit and reporting application 37a which interacts with database 35 to generate reports regarding the usage, aging, balances, and transaction history of the accounts; an account generation and issuance application 37b which allows business to create and issue new accounts to consumers; a web page server application 37c which serves web pages; an interface application 37d for electronic cash registers, point-of-sale terminals, and debit/credit terminals which receives messages from and transmits messages to electronic cash registers, point-of-sale terminals, and/or debit/credit terminals; an application 37e for generating electronic vouchers which receives messages from and transmits messages to devices 12 which are capable of printing out coupons or vouchers; an interface application 37f for a wireless gateway which receives messages from and transmits messages to devices 12 which communicate with ASP 16 via a wireless gateway; a secure transaction application 37g which provides a means for receiving secure or encrypted information such as personal identification numbers (PIN) or passwords from devices 12, decrypting the secure or encrypted information, processing of the secure or encrypted information, and, if necessary, re-encrypting the decrypted secure or encrypted information; a business/consumer inquiry/support application 37h which receives messages from and transmits messages to devices 12 in response to business/consumer support inquiries; a marketing application 37i which enables businesses to, among other things, monitor consumer purchasing behavior/purchasing history and attach special flags to consumer accounts based on that purchasing behavior/purchasing history, generate email or land-based direct marketing mailings based on the monitored consumer purchasing behavior/purchasing history, suggest to consumers goods and/or services to purchase based on the consumer's purchasing behavior/purchasing history, and allows consumers to, among other things, sign up for email or land-based mail notification of special offers or sales; a network interface application 37j which enables ASP 16 to communicate with network 14; consumer account management application 37k which keeps track of and analyzes customer account information and loyalty points or cash equivalents and can be accessed by consumers and businesses, but can only be modified by authorized personal of businesses; and a security module interface program 37l which enables server 31 to communicate with security module 36.

FIG. 4B is a block diagram of an exemplary database 35, according to some embodiments of the present invention. Database 35 is partitioned into a plurality of groups 41N (where N=a, b, c, etc.). Each group 41 is associated with a business. For example, group 41a can be associated with Business A, group 41b can be associated with Business B, and so on. Each group 41 includes a plurality of accounts 42N (where N=a, b, c, etc.). Each account 42 is associated with a consumer. For example, account 42a of group 41a can be associated with Business A and Consumer 1, account 42b of group 41a can be associated with Business A and Consumer 2, account 42a of group 41b can be associated with Business B and Consumer 11, account 42b of group 41b can be associated with Business B and Consumer 12, and so on.

Each account 42 holds cash equivalents which have a value. The cash equivalents may be electronic cash, loyalty points, a percentage discount, or the like. The value of the cash equivalents in the account can be increased and decreased in various situations as described below.

The value of the cash equivalents in a consumer's account can be increased if the consumer makes a purchase from the business that issued the account. The business may permit the value of the cash equivalents to increase if the consumer makes a purchase using cash, a check, a gift certificate, and/or a credit card issued by the business. Generally, business will not allow a the value of the cash equivalents in a consumer's account to increase in value if the consumer makes a purchase using a credit card issued by a third party such as Visa or MasterCard. As a result, a consumer will have an incentive to use a credit card issued by the business rather than a credit card issued by a third party since the value of the cash equivalents in the consumers account will increase when a purchase is made.

The value of the cash equivalents in a consumer's account can be increased at an accelerated rate or some other predetermined rate under business sponsored promotions, created by a business, which are designed to encourage consumers to make purchases of goods and/or services at the business. For example, a business could run a promotion over a holiday weekend that encourages consumers to shop during that weekend. Under the promotion, if a consumer makes a purchase during the holiday weekend, the value of the cash equivalents in the consumer's account will increase at an accelerated rate (e.g., twice the normal rate) or some other predetermined rate.

As another example, a business could run a promotion that encourages consumers to make purchases using the Internet (e.g., by using the business' e-commerce enabled web site). Under the promotion, if a consumer makes a purchase over the Internet, the value of the cash equivalents in the consumer's account will increase at an accelerated rate (e.g., twice the normal rate) or some other predetermined rate.

As another example, a business could run a promotion that encourages consumers to make frequent purchases. Under the promotion, if a consumer makes frequent purchases (e.g., five purchases from the business in a month), the value of the cash equivalents in the consumer's account will be increased at an accelerated rate (e.g., twice the normal rate) or by some other predetermined amount.

The value of the cash equivalents in a consumer's account can also be increased if consumers “deposit” money into their accounts. The money can be deposited into the accounts at a one-to-one ratio or at a ratio that is greater than one-to-one. Consumers can then use the cash equivalents in their accounts to purchase goods and/or services from the business.

The value of the cash equivalents in a consumer's account can also be increased by earning interest. Businesses can allow the value of the cash equivalents in a consumer's account to earn interest at a predetermined rate. The interest rate can be customized for each account or can be standard for all accounts. For example, a business may apply a high rate of interest to accounts belonging to loyal consumers, those consumers who make a large number of purchases at a business.

FIG. 4C is a diagram of an exemplary security module 36, according to some embodiments of the present invention. Security module 36 includes a microprocessor 36a which is capable of executing one or more computer programs 36b stored in memory 36c.

Security module 36 receives encrypted identification information such as PIN numbers, passwords, and the like from devices 12 operated by consumers. The identification information is then decrypted within a physically and logically secure envelope. Next, security module 36 queries database 35 and compares the decrypted identification information to associated identification information in database 35. Based on the results of the comparison, security module 36 provides the application with the results (e.g., “OK” or “NOT OK”). If necessary, security module 36 can re-encrypt the identification information for transmittal to another network or computing device.

Thus, an exemplary application service provider (ASP) 16, according to some embodiments of the present invention, has been described. ASP 16 of system 4 allows a plurality of businesses to outsource the management of a plurality of accounts issued by the businesses to ASP 16. This may be advantageous in cases where a business does not have the capital, computer knowledge/capabilities, and/or security knowledge/capabilities required to manage the consumer accounts. In many situations, it will also cost less to outsource the management function to ASP 16 than to implement the application within the business even if the business has the capital, computer knowledge, and/or security knowledge required to manage the consumer accounts. Further, outsourcing the management of the accounts to an ASP allows businesses to implement the present invention in a quick and secure manner.

It should be recognized that the functions performed by and components implemented at ASP 16 described above can similarly be performed by and implemented at business computer system 18. Thus, business computer system 18 can include a server having a microprocessor and a memory where computer programs are stored, a database, and a security module.

Consumer Account Generation

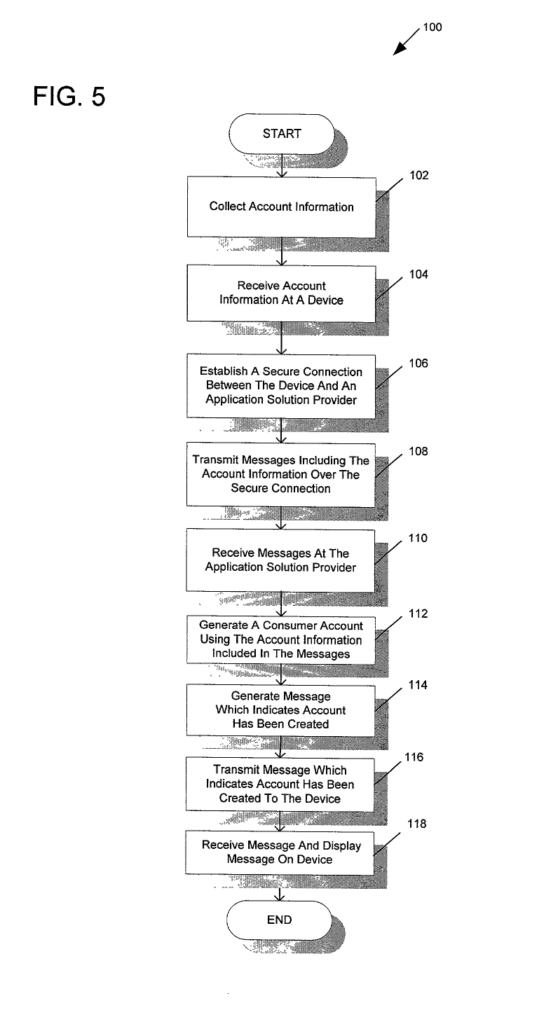

FIG. 5 is a flowchart of an exemplary method 100 for generating a consumer account, according to some embodiments of the present invention. The description of method 100 assumes that the consumer's account is generated at a business using device 12a (e.g., an electronic cash register), and that the business uses an application solution provider 16 to manage the account (FIG. 1B). It should be recognized, however, that method 100 can be modified such that the consumer's account does not have to be generated at a business, that the account can be generated using any of the devices 12 mentioned above, and that the business can manage the account itself (FIG. 1A). Reference is made to FIGS. 1B, 2, and 5 in describing method 100.

In step 102, account information is collected. The account information may include information such as the consumer's name and address, an identification code provided by the consumer, a bio-metric identification, and/or a code associated with a magnetic card such as a credit card or debit card. Such information can be collected using device 12a and, in particular, the input keypad 26, the magnetic card reader 27, and/or the authentication port 28.

In step 104, one or more computer programs running on microprocessor 22 of device 12a receive the account information. The computer programs then generate one or more messages including the account information. The computer programs may then encrypt the messages using conventional encryption techniques.

In step 106, the computer programs running on microprocessor 22 of device 12a establish a secure connection with ASP 16 over connection 11 a, business computer system 18, connection 17, network 14, and connection 19. Prior to initiating method 100, the business will have established a relationship with ASP 16 whereby ASP 16 allows the business to generate accounts using services provided by ASP 16. As such, the messages generated in step 104 also include information which identifies the business.

In step 108, the messages including the account information are transmitted from device 12a to ASP 16 over network 14.

In step 110, the messages are received by one or more computer programs running at ASP 16. If the messages have been encrypted, the computer programs running at ASP 16 decrypt the messages using conventional decryption techniques.

In step 112, the computer programs running at ASP 16 use the information contained in the messages to generate a consumer account. The computer programs store the consumer account on a database at ASP 16. The account can be identified by the business that issued the account and the consumer to whom the account belongs. As described above, the value of the account can increase in numerous situations, such as when the consumer makes a purchase from the business.

In step 114, the computer programs running at ASP 16 generate one or more messages, which indicate that the account has been created.

In step 116, the computer programs running at ASP 16 transmit the messages from ASP 16 to device 12a via network 14.

In step 118, the computer programs running on device 12a receive the messages and cause the information in the messages to be displayed on display 25.

Consumer Purchases

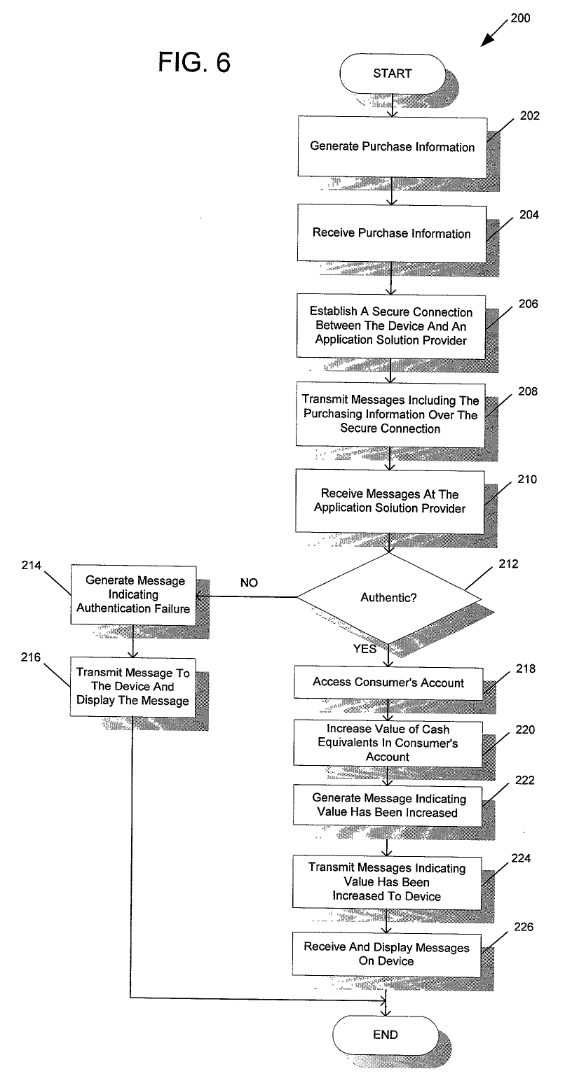

FIG. 6 is a flowchart of an exemplary method 200 for increasing the value of a consumer's account, according to some embodiments of the present invention. In particular, method 200 describes how a value of a consumer's account is increased if the consumer makes a purchase from the business that issued the account to the consumer. The description of method 200 assumes that the consumer's account is generated at a business using device 12a (e.g., an electronic cash register), and that the business uses an application solution provider 16 to manage the account (FIG. 1B). It should be recognized, however, that method 200 can be modified such that the consumer's account does not have to be generated at a business, that the account can be generated using any of the devices 12 mentioned above, and that the business could manage the account itself (FIG. 1A). Reference is made to FIGS. 1B, 2, and 6 in describing method 200.

In step 202, purchase information is generated when a consumer makes a purchase. At the time a consumer makes a purchase, the consumer or an employee at a business can swipe the consumer's credit card, which has been issued by the business, through magnetic card reader 27. The consumer may also be required to enter an identification number or password on input keypad 26 and/or provide other means of identification using authentication port 28. Authentication port 28 can be adapted to receive a bio-metric identification, a hardware token, or a smart card. The credit card information, identification information entered via keypad 26, and identification information received from authentication port 28, coupled with information indicating the purchase amount is collectively referred to herein as purchase information.

In step 204, one or more computer programs running on microprocessor 22 of device 12a receive the purchase information. The computer programs then generate one or more messages including the purchase information. The computer programs may then encrypt the messages using conventional encryption techniques.

In step 206, the computer programs running on microprocessor 22 of device 12a establish a secure connection with ASP 16 over connection 11a, business computer system 18, connection 17, network 14, and connection 19.

In step 208, the messages including the purchase information are transmitted from device 12a to ASP 16 over network 14.

In step 210, the messages are received by one or more computer programs running at ASP 16. If the messages have been encrypted, ASP 16 also decrypts the messages using conventional decryption techniques.

In step 212, the computer programs running at ASP 16 authenticate the messages using conventional authentication techniques. If the messages are not successfully authenticated, the computer programs can generate a message indicating that the account inquiry was not successfully authenticated (step 214). The message can then be transmitted to the computer programs on device 12a which cause the information to be displayed on display 25 (step 216). If the messages are successfully authenticated, method 200 proceeds to step 218.

In step 218, the computer programs running at ASP 16 access the consumer's account which is located on a database at ASP 16. The computer programs use the information contained in the messages to access the account.

In step 220, the computer programs increase the value of the cash equivalents in the consumer's account. For example, if the account holds electronic cash, the current balance of the account is $100.00, and the consumer has been credited with $5.00 of electronic cash for making a purchase, the computer programs will increment the value of the consumer's account such that it holds $105.00.

In step 222, the computer programs running at ASP 16 generate one or more messages, which indicate that the value of the account has been increased. The messages may also include the account history or other information related to the account.

In step 224, the computer programs running at ASP 16 transmit the messages from ASP 16 to device 12a via network 14.

In step 226, the computer programs running on device 12a receive the messages and cause the information in the messages to be displayed on display 26. The consumer can then review information about their account such as the account balance or the transaction history.

Coupon or Voucher Issuance

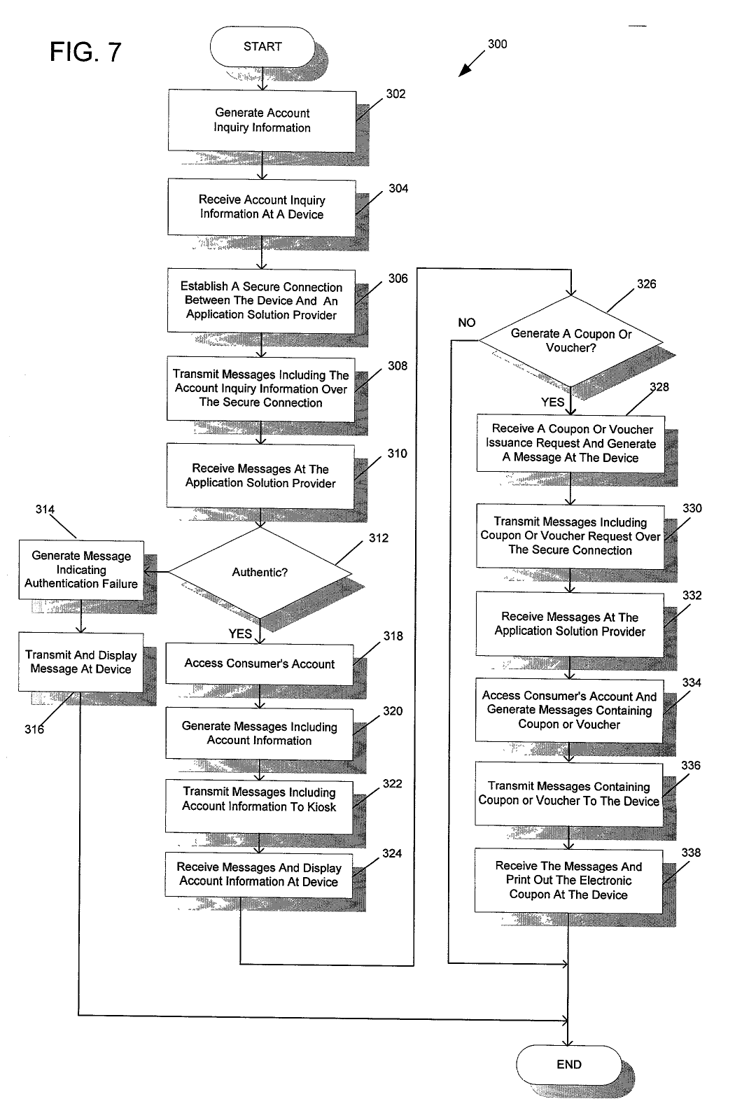

FIG. 7 is a flowchart of an exemplary method 300 for generating a coupon or voucher, according to some embodiments of the present invention. In particular, exemplary method 300 describes how a consumer can use a device which is attached to a printer to print out a coupon or voucher. The description of method 300 assumes that the consumer's account is generated at a business using a device 12a (e.g., an electronic kiosk), and that the business uses an application solution provider to manage the account (FIG. 1B). It should be recognized, however, that method 300 can be modified such that the consumer's account does not have to be generated at a business, that the account can be generated using any of the devices 12 mentioned above, and that the business could manage the account itself (FIG. 1A). Reference is made to FIGS. 1B, 2, and 7 in describing method 300.

In step 302, account inquiry information is generated when a consumer makes an account inquiry. Display 25 can prompt the consumer to swipe the consumers credit card through magnetic card reader 27. The consumer may also be prompted via display 25 to enter an identification number or password on input keypad 26 and/or provide other means of identification using authentication port 28. Authentication port 28 can include a bio-metric device, a hardware token, or a smart card. The credit card information, identification information entered via keypad 26, and identification information received from authentication port 28, coupled with information indicating the purchase amount is referred to herein as account inquiry information.

In step 304, one or more computer programs running on microprocessor 22 of device 12a receive the account inquiry information. The computer programs then generate one or more messages including the account inquiry information. The computer programs may then encrypt the messages using conventional encryption techniques.

In step 306, the computer programs running on microprocessor 22 of device 12a establish a secure connection with ASP 16 over connection 11a, business computer system 18, connection 17, network 14, and connection 19.

In step 308, after a secure connection has been established, the messages are transmitted from device 12a to ASP 16 over network 14.

In step 310, the messages are received by one or more computer programs running at ASP 16. If the messages have been encrypted, ASP 16 decrypts the messages using conventional decryption techniques.

In step 312, the computer programs running at ASP 16 authenticate the messages using conventional authentication techniques. If the messages are not successfully authenticated, the computer programs can generate a message indicating that the account inquiry was not successfully authenticated (step 314). The message can then be transmitted to the computer programs on device 12a which cause the information to be displayed on display 25 (step 316). If the messages are successfully authenticated, method 300 proceeds to step 318.

In step 318, the computer programs running at ASP 16 access the consumer's account which is located on a database at ASP 16. The computer programs use the information contained in the messages to access the account.

In step 320, the computer programs running at ASP 16 generate one or more messages containing account information such as the account balance.

In step 322, the messages containing the account information are transmitted from ASP 16 to device 12a via network 14.

In step 324, the computer programs 24 running on device 12a receive the messages and cause the account information to be displayed on display 26.

In step 326, the computer programs present the consumer with the option of generating a coupon or voucher. If the consumer does not choose to generate a coupon or voucher, method 300 ends. If the consumer chooses to generate a coupon or voucher, the consumer can request a coupon or voucher to be issued, for example, by pressing a button on input keypad 26, and then method 300 continues to step 328.

In step 328, the computer programs receive a coupon or voucher issuance request and generate messages including the same. The messages may be encrypted using conventional encryption techniques.

In step 330, the messages including the coupon or voucher issuance requests are transmitted from device 12a to ASP 16 over network 14.

In step 332, the messages are received by one or more computer programs running at ASP 16. If the messages have been encrypted, ASP 16 also decrypts the messages using conventional decryption techniques.

In step 334, the computer programs running at ASP 16 access the consumer's account and generate one or more messages containing the electronic coupon or voucher. In generating the message containing the electronic coupon or voucher, the computer programs decrease the value of the cash equivalents in the consumer's account by an amount equal to the value of the coupon or voucher.

In step 336, the messages containing the coupon or voucher are transmitted back to device 12a via network 14.

In step 338, the computer programs 24 running on device 12a receive the messages and cause the electronic coupon to be printed on printer 30.

The consumer can then use the coupon when making a purchase. The value of the coupon can be determined at the time of purchase by scanning a bar code on the face of the coupon or entering a coupon code on the face of the coupon. This information is then verified with information stored at ASP 16 or business computer system 18 which indicates whether the coupon is valid.

Distribution of Non-Cash Benefits

The present invention can also be used by entities that offer goods and/or services without requiring cash payment. For example, benefits can be distributed using the present invention.

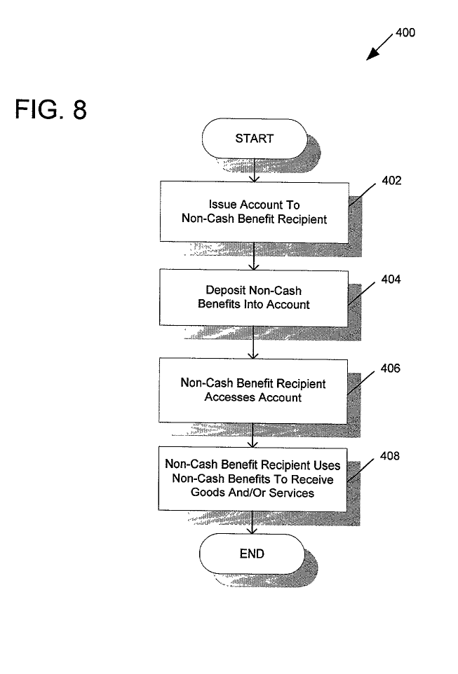

FIG. 8 is a flowchart of an exemplary method 400 for distributing benefits, according to some embodiments of the present invention. In particular, exemplary method 400 describes how benefits (e.g., food stamps) can be distributed by a government agency. The description of method 400 assumes that a benefit recipient accesses their account at a business using a device 12a (e.g., an debit/credit terminal), and that the government agency uses an application solution provider 16 to manage the account (FIG. 1B). Reference is made to FIGS. 1B, 2, and 8 in describing method 400.

In step 402, a government agency issues an account, which is stored at ASP 16, to a benefit recipient. The account can be identified by identification information such as an identification code, a password, a code embedded in a magnetic strip on a magnetic card, a bio-metric identification, and/or the like. The identification information can be supplied by the benefit recipient and/or the governmental agency.

In step 404, the governmental agency can increase the value of the account by depositing benefits into the account. The governmental agency can make such deposits periodically (e.g., monthly).

In step 406, the benefit recipient accesses the account. For example, the benefit recipient can use device 12a to access their account. The benefit recipient can provide identification information such as an identification code, a password, a code embedded in a magnetic strip on a magnetic card, a bio-metric identification, and/or the like. This information is received by one or more computer programs running on device 12a, device 12a generates and transmits a message over secure network 14 to ASP 16, and ASP accesses the account and transmits messages over secure network 14 to device 12a which are displayed on display 25, as described above.

In step 408, the benefit recipient uses the benefits in the account as payment for goods and/or services. For example, the benefit recipient can apply the value of the account to a current purchase via device 12a (e.g., a debit/credit terminal) when making a purchase. Alternatively, the benefit recipient can print out a voucher using an electronic kiosk attached to a printer and use the voucher when making a purchase.

The distribution of benefits using the present invention is advantageous since it provides a more reliable and secure method of distributing non-cash benefits when compared to conventional techniques.

Advantages of the Present Invention

There are several important advantages provided to businesses by the present invention. First, businesses can improve and promote consumer loyalty by providing incentives in the form of cash equivalents to consumers, if consumers purchase goods and/or services from the business. Second, Internet based shopping can be promoted and increased. Businesses can run promotions which allow consumers to increase the value of the cash equivalents in their accounts at a higher rate if the consumers make purchase using the businesses' e-commerce enabled websites. Third, businesses can encourage consumers to use business issued credit cards rather than third party issued credit cards by providing incentives in the form of cash equivalents to consumers, if consumers to purchase goods and/or services from the business using the business issued credit cards. This reduces third party transaction fees, thereby increasing the businesses profits. At the same time, businesses increase revenues by generating interest income from the outstanding credit card balances of their consumers. Fourth, businesses can improve direct marketing campaigns. Businesses can monitor the purchasing behavior of consumers using a computer program located at the application solution provider or the business computer system. This information can then be used to direct market appropriate goods and/or services to consumers. Fifth, businesses can improve their operations with minimal cost. Businesses can implement the system of the present invention without having to rebuild their infrastructures as they would with other technologies (e.g., with smart cards). Businesses can instead load computer programs which enable the present invention to be performed onto their existing electronic cash registers, point-of-sale terminals, and debit/credit terminals. Thus, rather than replacing hardware, businesses only need to make a relatively simple software upgrade. Sixth, businesses can outsource the management of the accounts to and ASP. This is advantageous since many businesses do not have enough capital and security knowledge to implement their own branded electronic cash program. Outsourcing the management of the accounts to an ASP also allows businesses to implement the present invention in a quick and secure manner.

What is claimed is:

1. A computer readable storage medium storing one or more computer programs, the computer programs comprising instructions for:
receiving one or more messages from a device;
accessing a database having a plurality of accounts;
identifying an account located within the database using information contained in the messages, the account being issued by a business to a consumer; and
if the messages include information indicating that that consumer has made a purchase from the business, increasing a value of the account.

2. The computer readable storage medium of claim 1 wherein the value of the account increases if the consumer makes a purchase using cash.

3. The computer readable storage medium of claim 1 wherein the value of the account increases if the consumer makes a purchase using a credit card issued by the business.

4. The computer readable storage medium of claim 1 wherein the value of the account increases at an accelerated rate if the consumer makes a purchase from the business during a specified time period.

5. The computer readable storage medium of claim 1 wherein the value of the account increases at an accelerated rate if the consumer makes a purchase from the business over the Internet.

6. The computer readable storage medium of claim 1 wherein the value of the account increases at an accelerated rate if the consumer makes frequent purchases from the business.

7. The computer readable storage medium of claim 1 wherein the consumer can use the value of the account to purchase goods and/or services from the business.

8. The computer readable storage medium of claim 1 wherein the value of the account increases at a one-to-one ratio if the consumer deposits money into the account.

9. The computer readable storage medium of claim 1 wherein the value of the account increases at a ratio which is greater than one-to-one by if the consumer deposits money into the account.

10. The computer readable storage medium of claim 1 wherein the value of the account accrues interest at a predetermined rate.

11. The computer readable storage medium of claim 1 wherein the computer programs further comprise instructions for authenticating information contained in the messages.

12. The computer readable storage medium of claim 1 wherein the computer programs further comprise instructions for decrypting the messages.

13. The computer readable storage medium of claim 1 wherein the computer programs further comprise instructions for sending messages to the device which include the value of the account and/or an account history.

14. The computer readable storage medium of claim 1 wherein the computer programs further comprise instructions for sending messages to the device which include information that suggests the type or types of goods and/or services to purchase.

15. The computer readable storage medium of claim 1 wherein the messages are received from a secure network.

16. The computer readable storage medium of claim 1 wherein the device is an electronic cash register, a point-of-sale terminal, a debit/credit terminal, an electronic kiosk, a cellular telephone, a personal digital assistant, a home computer, or a business computer.

17. The computer readable storage medium of claim 1 wherein the messages include one or more of the following: a credit card number, a personal identification code, a bio-metric identification, a password, or a token.

18. The computer readable storage medium of claim 1 wherein the computer programs run on a computer system managed by an application service provider.

19. The computer readable storage medium of claim 1 wherein the computer programs run on a computer system managed by the business that issued the account.

20. A computer system comprising:
one or more computers;
one or more memories coupled to the computers; and
one or more computer programs running on the computers, the computer programs including computer instructions for:
receiving one or more messages from a device;
accessing a database having a plurality of accounts;
identifying an account located within the database using information contained in the messages, the account being issued by a business to a consumer; and
if the messages include information indicating that that consumer has made a purchase from the business, increasing a value of the account.

21. The computer system of claim 20 wherein the value of the account increases if the consumer makes a purchase using cash.

22. The computer system of claim 20 wherein the value of the account increases if the consumer makes a purchase using a credit card issued by the business.

23. The computer system of claim 20 wherein the value of the account increases at an accelerated rate if the consumer makes a purchase from the business during a specified time period.

24. The computer system of claim 20 wherein the value of the account increases at an accelerated rate if the consumer makes a purchase from the business over the Internet.

25. The computer system of claim 20 wherein the value of the account increases at an accelerated rate if the consumer makes frequent purchases from the business.

26. The computer system of claim 20 wherein the consumer can use the value of the account to purchase goods and/or services from the business.

27. The computer system of claim 20 wherein the value of the account increases at a one-to-one ratio if the consumer deposits money into the account.

28. The computer system of claim 20 wherein the value of the account increases at a ratio which is greater than one-to-one by if the consumer deposits money into the account.

29. The computer system of claim 20 wherein the value of the account accrues interest at a predetermined rate.

30. The computer system of claim 20 wherein the computer programs further comprise instructions for authenticating information contained in the messages.

31. The computer system of claim 20 wherein the computer programs further comprise instructions for decrypting the messages.

32. The computer system of claim 20 wherein the computer programs further comprise instructions for sending messages to the device which include the value of the account and/or an account history.

33. The computer system of claim 20 wherein the computer programs further comprise instructions for sending messages to the device which include information that suggests the type or types of goods and/or services to purchase.

34. The computer system of claim 20 wherein the messages are received from a secure network.

35. The computer system of claim 20 wherein the device is an electronic cash register, a point-of-sale terminal, a debit/credit terminal, an electronic kiosk, a cellular telephone, a personal digital assistant, a home computer, or a business computer.

36. The computer system of claim 20 wherein the messages include one or more of the following: a credit card number, a personal identification code, a bio-metric identification, a password, or a token.

37. The computer system of claim 20 wherein the computer system is managed by an application service provider.

38. The computer system of claim 20 wherein the computer system is managed by the business that issued the account.

39. A computer readable storage medium storing one or more computer programs, the computer programs comprising instructions for:
generating one or messages at a device if a consumer makes a purchase from a business, the messages containing information for identifying an account issued by the business to the consumer and the messages containing information for increasing a value of the account; and
sending the one or more messages to a computer system having access to the account.

40. The computer readable storage medium of claim 39 wherein the computer programs further comprise instructions for encrypting the message.

41. The computer readable storage medium of claim 39 wherein the computer programs further comprise instructions for receiving authentication information an authentication port, the authentication information for identifying whether the consumer can access the account.

42. The computer readable storage medium of claim 41 wherein the authentication information is a password, a personal identification code, a bio-metric identification, a smart card, or a security token.

43. The computer readable storage medium of claim 39 wherein the computer programs further comprise instructions for receiving from a magnetic card reader the information for identifying the account.

44. The computer readable storage medium of claim 39 the computer programs further comprise instructions for receiving from an input keypad information for identifying the account.

45. The computer readable storage medium of claim 39 wherein the device is an electronic cash register, a point-of-sale terminal, a debit/credit terminal, an electronic kiosk, a cellular telephone, a personal digital assistant, a home computer, or a business computer.

46. The computer program readable storage medium of claim 39 wherein the one or more computer programs have a segmented architecture.

47. A device comprising:
one or more processors;
one or more memories coupled to the processors; and
one or more computer programs running on the processors, the computer programs including computer instructions for:
generating one or messages at a device if a consumer makes a purchase from a business, the messages containing information for identifying an account issued by the business to the consumer and the messages containing information for increasing a value of the account; and
sending the one or more messages to a computer system having access to the account.

48. The device of claim 47 wherein the computer programs further comprise instructions for encrypting the message.

49. The device of claim 47 wherein the computer programs further comprise instructions for receiving authentication information an authentication device, the authentication information for identifying whether the consumer can access the account.

50. The device of claim 49 wherein the authentication information is a password, a personal identification code, a bio-metric identification, a smart card, or a security token.

51. The device of claim 47 wherein the computer programs further comprise instructions for receiving from a magnetic card reader the information for identifying the account.

52. The device of claim 47 wherein the computer programs further comprise instructions for receiving from an input keypad information for identifying the account.

53. The device of claim 47 wherein the device is an electronic cash register, a point-of-sale terminal, a debit/credit terminal, an electronic kiosk, a cellular telephone, a personal digital assistant, a home computer, or a business computer.

54. The device of claim 47 wherein the one or more computer programs have a segmented architecture.

55. A method for providing a consumer with an incentive to purchase goods and/or services from a business, the method comprising:
providing the consumer with an account issued by the business; and
increasing a value of the account if the consumer makes a purchase from the business.

56. The method of claim 55 wherein the value of the account increases if the consumer makes a purchase using cash.

57. The method of claim 55 wherein the value of the account increases if the consumer makes a purchase using a credit card issued by the business.

58. The method of claim 55 wherein the value of the account increases at an accelerated rate if the consumer makes a purchase from the business during a specified time period.

59. The method of claim 55 wherein the value of the account increases at an accelerated rate if the consumer makes a purchase from the business over the Internet.

60. The method of claim 55 wherein the value of the account increases at an accelerated rate if the consumer makes frequent purchases from the business.

61. The method of claim 55 wherein the consumer can use the value of the account to purchase goods and/or services from the business.

62. The method of claim 55 wherein the value of the account increases at a one-to-one ratio if the consumer deposits money into the account.

63. The method of claim 55 wherein the value of the account increases at a ratio which is greater than one-to-one by if the consumer deposits money into the account.

64. The method of claim 55 wherein the value of the account accrues interest at a predetermined rate.

65. A method for distributing benefits, the method comprising:
receiving one or more messages from a device;
accessing a database containing a plurality of accounts;
identifying an account located within the database using information contained in the messages, the account being associated with a benefit recipient; and
decreasing a value of the account, if the messages include information indicating that that benefit recipient has purchased goods and/or services from a business.

66. The method of claim 65 wherein the value of the account increases if a governmental agency deposits non-cash benefits into the account.

67. The method of claim 65 further comprising authenticating information contained in the messages.

68. The method of claim 65 further comprising decrypting the messages.

69. The method of claim 65 further comprising sending messages to the device which include the value of the account and/or an account history.

70. The method of claim 65 wherein the messages are received from a secure network.

71. The method of claim 65 wherein the device is an electronic cash register, a point-of-sale terminal, a debit/credit terminal, an electronic kiosk, a cellular telephone, a personal digital assistant, a home computer, or a business computer.

72. The method of claim 65 wherein the messages include one or more of the following: a credit card number, a personal identification code, a bio-metric identification, a password, or a token.

73. The method of claim 65 wherein the steps of receiving, accessing, identifying, and decreasing occur at an application service provider.
